(19) United States
(12) Patent Application Publication
(10) Pub. No.: US 2024/0205182 A1
(43) Pub. Date: Jun. 20, 2024

(54) INDIVIDUAL ATTRIBUTE-BASED TRANSMISSION ASPECT DETERMINATION

(71) Applicant: Rakuten Mobile, Inc., Tokyo (JP)

(72) Inventors: Mami HARIYA, Tokyo (JP); Rina TAKAMATSU, Tokyo (JP); Anshul BHATT, Tokyo (JP)

(21) Appl. No.: 17/911,135

(22) PCT Filed: Feb. 4, 2022
(86) PCT No.: PCT/US2022/015186

§ 371 Date: Sep. 13, 2022

(51) Int. Cl. H04L 51/214; H04L 51/222

(52) U.S. Cl. CPC H04L 51/214; H04L 51/222

(57) ABSTRACT

Individual attribute-based transmission aspect determination is performed by receiving a communication associated with a target attribute, selecting, from a list of individual identifiers, an individual identifier for transmission of the communication based on the target attribute, determining, for the selected individual identifier, a transmission aspect in which to transmit the communication, and transmitting the communication through the determined transmission aspect.

### BACKGROUND

Messages are often transmitted to individuals included in a mailing list. Such messages may include information applicable to certain age groups or other demographic. Some messages may include information applicable to certain locations, but not to others. In many cases, each message is transmitted to everyone included the mailing list.

Such messages can be transmitted according to various transmission aspects. Some messages are transmitted through email while others are transmitted through Short Message Service (SMS) messages. Some messages are transmitted at night while others are transmitted during the day. In many cases, the aspects of the message transmission are the same for all individuals included in the mailing list. Messages

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for individual attribute-based transmission aspect determination, according to at least some embodiments of the present invention.

FIG. 2 is a communication template, according to at least some embodiments of the present invention.

FIG. 3 is an operational flow for individual attribute-based transmission aspect determination, according to at least some embodiments of the present invention.

FIG. 4 is an operational flow for individual identifier selection, according to at least some embodiments of the present invention.

FIG. 5 is an operational flow for transmission time determination, according to at least some embodiments of the present invention.

FIG. 6 is an operational flow for transmission channel determination, according to at least some embodiments of the present invention.

FIG. 7 is an operational flow for attribute association based on previously transmitted communications, according to at least some embodiments of the present invention.

FIG. 8 is a block diagram of a hardware configuration for individual attribute-based transmission aspect determination, according to at least some embodiments of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Marketing teams routinely send messages, emails, letters, etc., based on a mailing list to customers, but sending to everyone on the mailing list in the same manner does not make use of further opportunities for efficient use of resources. When a marketing team plans a promotional campaign and sends promotional communications, their goal is for customers to act on those communications. Selecting applicable recipients and transmitting according to aspects favorable to an individual increase the likelihood that the individual acts on the communication. At least some embodiments herein use less computational resources because there is a reduction in number of customers that receive each communication.

At least some embodiments herein include choosing the preferred way to communicate with each customer. In at least some embodiments, a segmentation engine is configured to extract the correct audience for a given communication. At least some embodiments include identifying whether to send an email, SMS, and other transmission aspects of a given communication for each recipient.

In at least some embodiments, communications are personalized based on time, location, event, etc. In at least some embodiments, personalization is based on past behavior of a customer. For example, when customer opens an email or other message, a notification is received, and statistics are collected concerning a customer's favorite communication tools.

In at least some embodiments, transmission aspects are based on time of day. For example, if the transmission is very late at night, then an email is more likely to be suitable. At least some embodiments include predicting the right time to send a communication to increase the likelihood of engagement. For example, if a customer always opens an email at 3 pm, then at least some embodiments are configured to identify this pattern, and transmit an email communication at about 3 pm. At least some embodiments are configured to recognize whether the customer is a mother, and respond by refraining from transmission at night or when she otherwise needs to take care of children.

In at least some embodiments, transmission aspects are based on location, such as by using geolocation for Instagram. For example, if there is no 5G service in a certain area, at least some embodiments are configured to recognize individuals in that area, and forgo promoting 5G to individuals in that area. At least some embodiments include utilizing customer network location data to identify customer location, which gives certain location data.

At least some embodiments include utilizing past campaign data to estimate optimal transmission aspects for contacting a customer, or estimating preferred content of a user. For example, if a customer uses many services from a specific provider, then at least some embodiments are configured to recognize the customer loyalty, and increase priority in communicating new services of that specific provider.

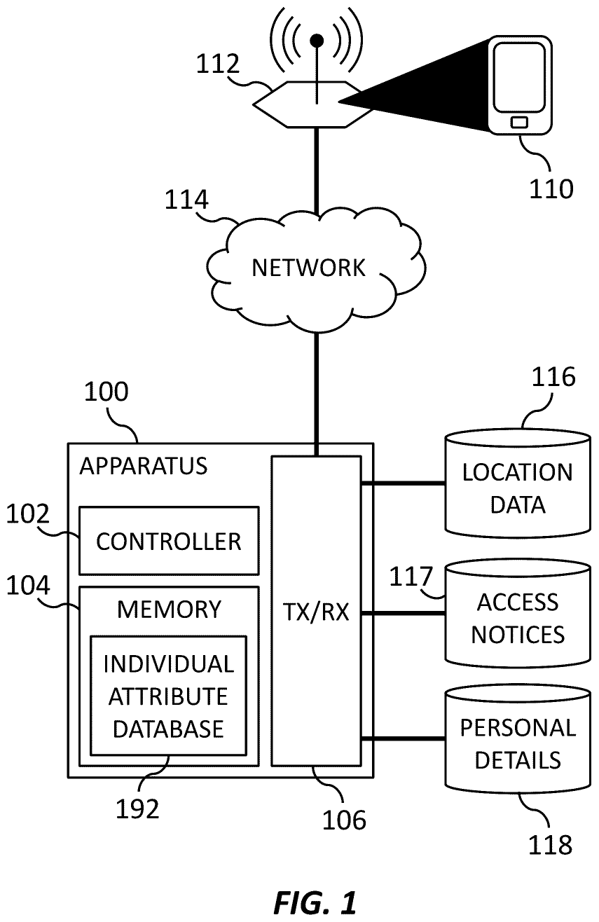

FIG. 1 is a schematic diagram of a system for individual attribute-based transmission aspect determination, according to at least some embodiments of the present invention. The system includes an apparatus 100, an individual communication device 110, an access point 112, a network 114, a location data database 116, an access notices database 117, and a personal detail database 118.

Apparatus 100 is configured to perform individual attribute-based transmission aspect determination. In at least some embodiments, apparatus 100 is a computer, such as a desktop computer, a server, a plurality of servers, or a portion of a server, a virtual instance of cloud computing, etc. Apparatus 100 includes a controller 102, a memory 104 including an individual attribute database 192, and a transceiver 106. In at least some embodiments, controller 102 is a microprocessor or other circuitry configured execute computer-readable instructions, and issue instructions to memory 104 and transceiver 106. In at least some embodiments, memory 104 includes one or more volatile and/or non-volatile computer-readable storage mediums. In at least some embodiments, transceiver 106 includes circuitry configured to communicate through wired or wireless signals according to one or more digital communication protocols.

In at least some embodiments, apparatus 100 is configured to retrieve information from one or more databases, including location data database 116, access notification database 117, and personal detail database 118. In at least some embodiments, apparatus 100 is configured to associate individual identifiers with attributes based on the information retrieved from the databases, and store resulting associations in individual attribute database 192. In at least some embodiments, an individual identifier is a unique data string, such as a number, an alphanumeric code, etc., that represents a user such that each user is represented by a single data string and each data string represents a single user. In at least some embodiments, apparatus 100 is configured to receive notices indicating that a previously transmitted communication associated with the individual identifier has been accessed, such as access notices from individual communication device 110, and store access notices in access notices database 117. In at least some embodiments, apparatus 100 is configured to associate individual identifiers with transmission aspects indicated in such access notices, and store resulting associations in individual attribute database 192. In at least some embodiments, apparatus 100 is configured to receive personal details, such as user-provided demographic information including age, gender, income, family details, etc., and store the user-provided demographic information in personal details database 118. In at least some embodiments, apparatus 100 is configured to associate individual identifiers with personal details, and store resulting associations in individual attribute database 192.

Individual communication device 110 is in communication with apparatus 100 through access point 112 of network 114. In at least some embodiments, individual communication device 110 is a computer, such as a desktop computer, notebook computer, handheld computer, Internet-of-Things (IoT) computing device, or any other device configured to receive communications and transmit access notices. In at least some embodiments, individual communication device 110 is configured to receive communication in the form of email and SMS messages, includes programming and output modules to display email and SMS messages, and includes further programming to generate and transmit access notices in response to receiving user input to display an email or SMS message. In at least some embodiments, individual communication device 110 is associated with an individual identifier, and communication from individual communication device 110 is also associated with the individual identifier.

Access point 112 is configured to relay communication between network 114 and individual communication device 110. In at least some embodiments, access point 112 is a radio access point and network 114 is a radio access network. In at least some embodiments, access point 112 is a local network router, and network 114 is the Internet. In at least some embodiments, access point 112 is associated with a geographic location, and communication relayed through access point 112 is also associated with the geographic location. In at least some embodiments, location data database 116 stores information related to geographic location of individual communication device 110 from transmissions from individual communication device 110 through access point 112. In at least some embodiments, apparatus 100 is configured to associate individual identifiers with a location based on an access point of the radio access network receiving the individual identifier to establish a connection, and store resulting associations in individual attribute database 192.

In at least some embodiments, location data database 116, access notices database 117, and personal detail database 118 are in communication with apparatus 100 through network 114. In at least some embodiments, each of location data database 116, access notices database 117, and personal detail database 118 includes a controller for receiving and recording information to the respective database.

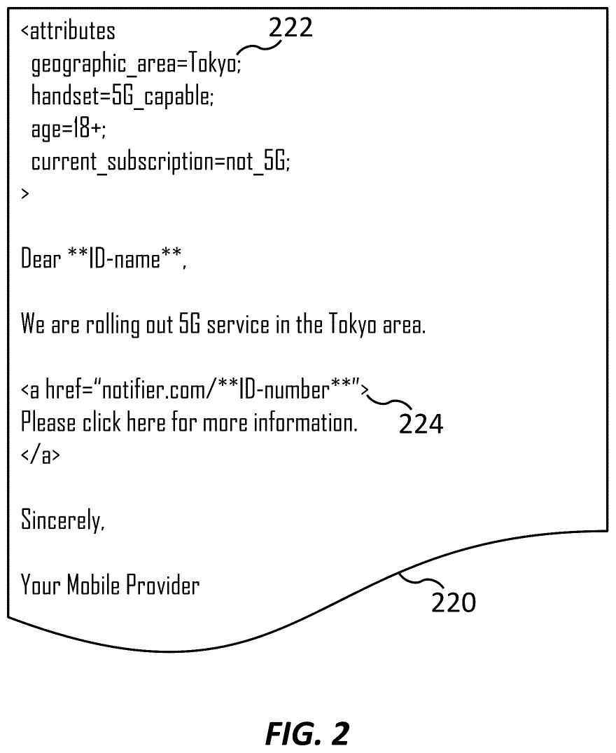

FIG. 2 is a communication template 220, according to at least some embodiments of the present invention. In at least some embodiments, communication template 220 is an email message, and SMS message, or a format compatible with both email and SMS protocols. Communication template 220 includes one or more target attributes 222, and an access notice trigger 224. In at least some embodiments, communication template 220 includes information visible to a reader that conveys a message about a product or service. In at least some embodiments, an apparatus, such as apparatus 100 in FIG. 1, receives communication template 220, selects individuals associated with target attributes 222, and transmits each selected individual a communication based on communication template 220 according to transmission aspects associated with the selected individual.

In at least some embodiments, target attributes 222 specifies the attributes of individuals to select for reception. In at least some embodiments, a target attribute includes a geographic area. Target attributes 222 specify individuals associated with “Tokyo” as a target geographic area, individuals who use 5G capable handsets, individuals who are at least 18 years old, and individuals who do not currently subscribe to 5G service. In at least some embodiments, the apparatus refers to a location data database, such as location data database 116 of FIG. 1, to find individuals associated with “Tokyo”, an access notices database, such as access notices database 117, to find individuals who have 5G capable handsets, and a personal details database, such as personal details database 118, to find individuals who are at least 18 and not currently subscribed to 5G. In at least some embodiments, the target attributes of communication templates will vary widely in number, scope, and specificity.

In at least some embodiments, access notice trigger 224 is a link to a script or program that sends an access notice to an apparatus, such as apparatus 100 of FIG. 1. In at least some embodiments, access notice trigger 224 is activated in response to an individual communication device being instructed by a user to follow the link of access notice trigger 224. In at least some embodiments, access notice trigger 224 is activated in response to an individual communication device being instructed to display the communication based on communication template 220.

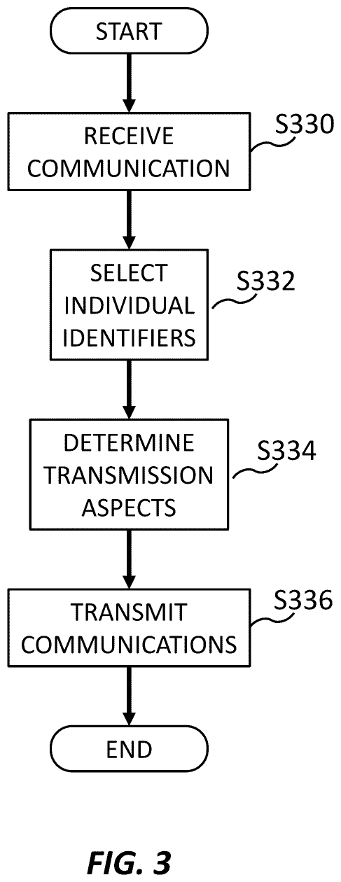

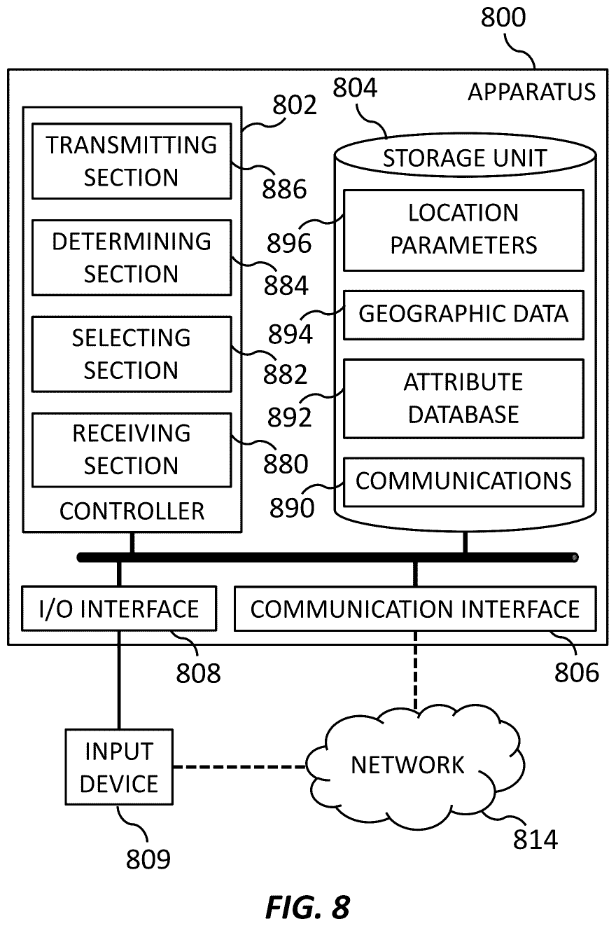

FIG. 3 is an operational flow for individual attribute-based transmission aspect determination, according to at least some embodiments of the present invention. The operational flow provides a method of individual attribute-based transmission aspect determination. In at least some embodiments, one or more operations of the method are executed by a controller of an apparatus including sections for performing certain operations, such as the controller and apparatus shown in FIG. 8, which will be explained hereinafter.

At S330, a receiving section receives a communication. In at least some embodiments, the receiving section receives a communication template. In at least some embodiments, the receiving section receives a communication associated with a target attribute. In at least some embodiments, the target attribute includes information associated with individual identifiers. In at least some embodiments, the target attribute includes information stored in a location data database, an access notices database, a personal details database, etc.

At S332, a selecting section selects individual identifiers. In at least some embodiments, the selecting section selects, from a list of individual identifiers, an individual identifier for transmission of the communication based on the target attribute. In at least some embodiments, the selecting section selects one or more individual identifiers associated with the information in the target attribute.

At S334, a determining section determines transmission aspects. In at least some embodiments, the determining section determines transmission aspects for each individual identifier selected based on the target attribute(s). In at least some embodiments, the determining section determines, for the selected individual identifier, a transmission aspect in which to transmit the communication. In at least some embodiments, the transmission aspect includes a transmission channel and a transmission time.

At S336, a transmitting section transmits communications. In at least some embodiments, the transmitting section transmits the communication to each selected individual in accordance with the determined transmission aspects. In at least some embodiments, the transmitting section transmits the communication through the determined transmission aspect.

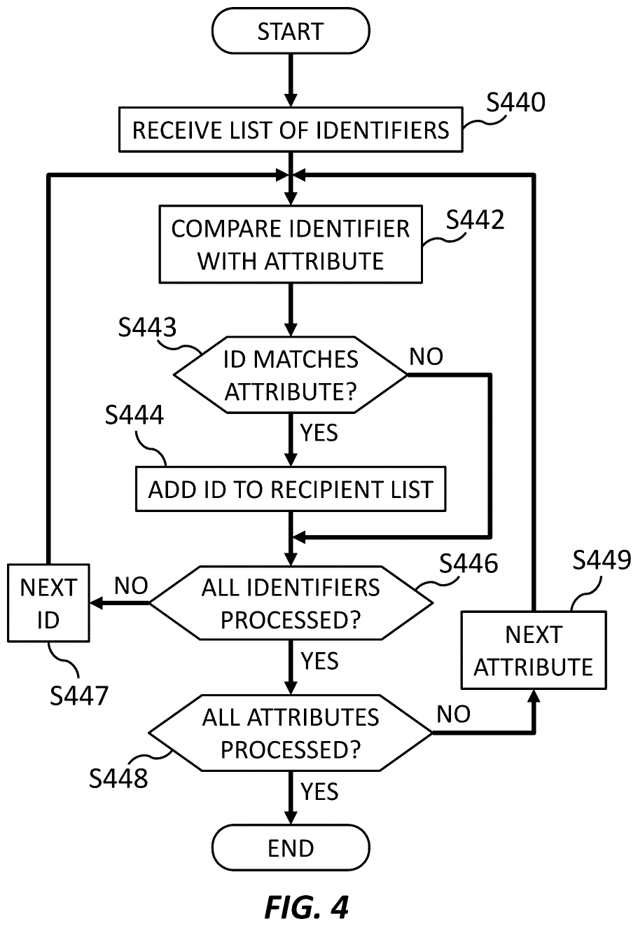

FIG. 4 is an operational flow for individual identifier selection, according to at least some embodiments of the present invention. The operational flow provides a method of individual identifier selection. In at least some embodiments, one or more operations of the method are performed by a selecting section of an apparatus, such as the apparatus shown in FIG. 8, which will be explained hereinafter.

At S440, the selecting section or a sub-section thereof receives a list of individual identifiers. In at least some embodiments, the selecting section receives a default list of individual identifiers. In at least some embodiments, the selecting section receives a pre-screened list of individual identifiers that includes fewer individual identifiers than a default list. In at least some embodiments, the selecting section receives a pre-screened list of individual identifiers from a server through a network. In at least some embodiments, the selecting section instructs the receiving section to receive the list of individual identifiers.

At S442, the selecting section or a sub-section thereof compares an individual identifier with a target attribute. In at least some embodiments, the selecting section compares the value of an applicable attribute associated with the individual identifier with a value of the target attribute. In at least some embodiments, the selecting section compares a geographic area of the target attribute to a location associated with the individual identifier. For example, in communication 220 of FIG. 2, target attributes 222 include “Tokyo” as a value of the target attribute “geographic_area”. In this example, the selecting section compares a value of a “geographic_area” attribute associated with the individual identifier with “Tokyo”. In at least some embodiments, the value of the “geographic_area” attribute associated with the individual identifier is “Tokyo” exactly, longitude and latitude values that are within a geographical area of Tokyo, a name of a suburb within a geographical area of Tokyo, or any other value that indicates a geographic location or area. In at least some embodiments, the selecting section compares more than one value of the “geographic_area” attribute associated with the individual identifier, such as a home location and a work location.

At S443, the selecting section or a sub-section thereof determines whether the individual identifier matches the target attribute. In at least some embodiments, the selecting section determines whether the value of the applicable attribute associated with the individual identifier is an acceptable match based on the value of the target attribute. For example, if the value of a target attribute for “geographic_area” is “Tokyo”, then an acceptable match includes a value of “Tokyo” exactly, longitude and latitude values that are within a geographical area of Tokyo, and a name of a suburb within a geographical area of Tokyo. If the selecting section determines that the individual identifier matches the target attribute, then the operational flow proceeds to add the individual identifier to a recipient list at S444. If the selecting section determines that the individual identifier does not match the target attribute, then the operational flow proceeds without adding the individual identifier to the recipient list.

At S446, the selecting section or a sub-section thereof determines whether all of the individual identifiers in the list received at S440 have been processed. If the selecting section determines that one or more individual identifiers in the list received at S440 remain unprocessed, then the operational flow returns to attribute comparison at S442 after selecting the next individual identifier at S447. If the selecting section determines that all of the individual identifiers in the list received at S440 have been processed, then the operational flow proceeds.

At S448, the selecting section or a sub-section thereof determines whether all of the target attributes in a communication have been processed. If the selecting section determines that one or more target attributes in the communication remain unprocessed, then the operational flow returns to attribute comparison at S442 after selecting the next target attribute at S449 to begin comparison of all individual identifiers in the list received at S440 with the newly selected target attribute. If the selecting section determines that all of the target attributes in the communication have been processed, then the operational flow ends.

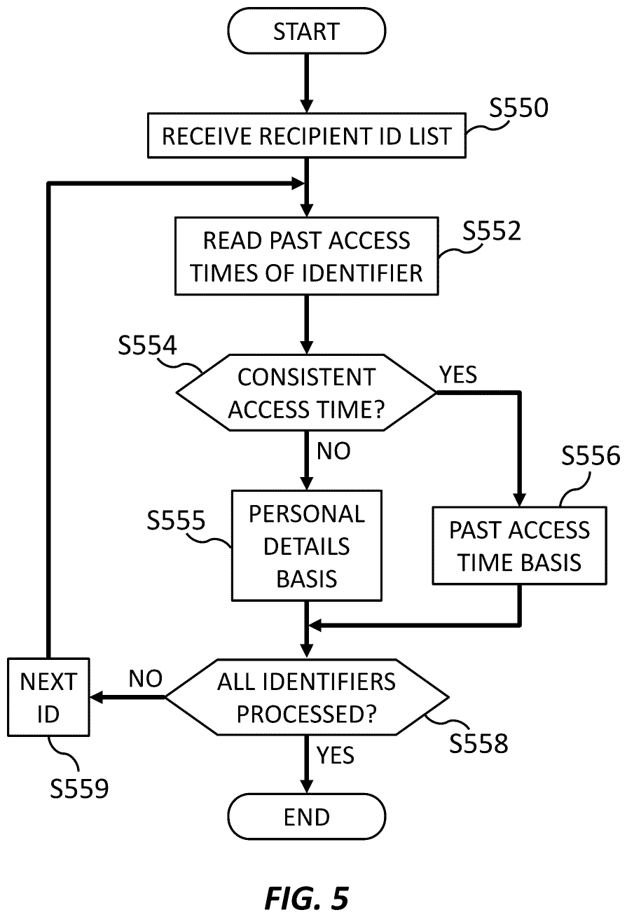

FIG. 5 is an operational flow for transmission time determination, according to at least some embodiments of the present invention. The operational flow provides a method of transmission time determination. In at least some embodiments, one or more operations of the method are performed by a determining section of an apparatus, such as the apparatus shown in FIG. 8, which will be explained hereinafter.

At S550, the determining section or a sub-section thereof receives a list of recipient individual identifiers. In at least some embodiments, the determining section receives a list of recipient individual identifiers from a selecting section. In at least some embodiments, the determining section instructs the receiving section to receive the list of recipient individual identifiers.

At S552, the determining section or a sub-section thereof reads past access times of an individual identifier. In at least some embodiments, the determining section reads past access times associated with the individual identifier in the recipient individual identifier list from an access notices database, such as access notices database 117 of FIG. 1. In at least some embodiments, the determining section reads pre-processed information describing access times of the individual identifier from an individual attribute database, such as individual attribute database 192 of FIG. 1.

At S554, the determining section or a sub-section thereof determines whether there is a consistent access time associated with the individual identifier. In at least some embodiments, the determining section determines whether a standard deviation of past access times associated with the individual identifier in an access notices database is less than a threshold value. In at least some embodiments, the determining section determines whether a pre-calculated standard deviation value stored in an individual attribute database is less than a threshold value. If the determining section determines that there is a consistent access time associated with the individual identifier, then the operational flow proceeds to past access time based transmission time determination at S556. If the determining section determines that there is not a consistent access time associated with the individual identifier, then the operational flow proceeds to personal detail based transmission time determination at S555.

At S555, the determining section or a sub-section thereof determines the transmission time based on personal details of the individual identifier. In at least some embodiments, the determining section reads user-provided demographic information from a personal details database, such as personal details database 118 of FIG. 1. In at least some embodiments, the determining section reads pre-processed user-provided demographic information from an individual attribute database, such as individual attribute database 192. In at least some embodiments, the determining section applies one or more rules for determining a transmission time based on personal details. For example, if the personal details reveal that the individual identifier is of a mother, then the determining section determines a transmission time that is not at night or when the mother otherwise needs to take care of children.

At S556, the determining section or a sub-section thereof determines the transmission time based on past access times of the individual identifier. In at least some embodiments, the determining section refers to the access time to determine the transmission time. In at least some embodiments, the determining section determines that the average past access time is the transmission time. In at least some embodiments, the determining section adjusts the past access time based transmission time based on personal details.

At S558, the determining section or a sub-section thereof determines whether all of the individual identifiers in the recipient list received at S550 have been processed. If the determining section determines that one or more individual identifiers in the recipient list received at S550 remain unprocessed, then the operational flow returns to past access time reading at S552 after selecting the next individual identifier at S559. If the selecting section determines that all of the individual identifiers in the recipient list received at S550 have been processed, then the operational flow ends.

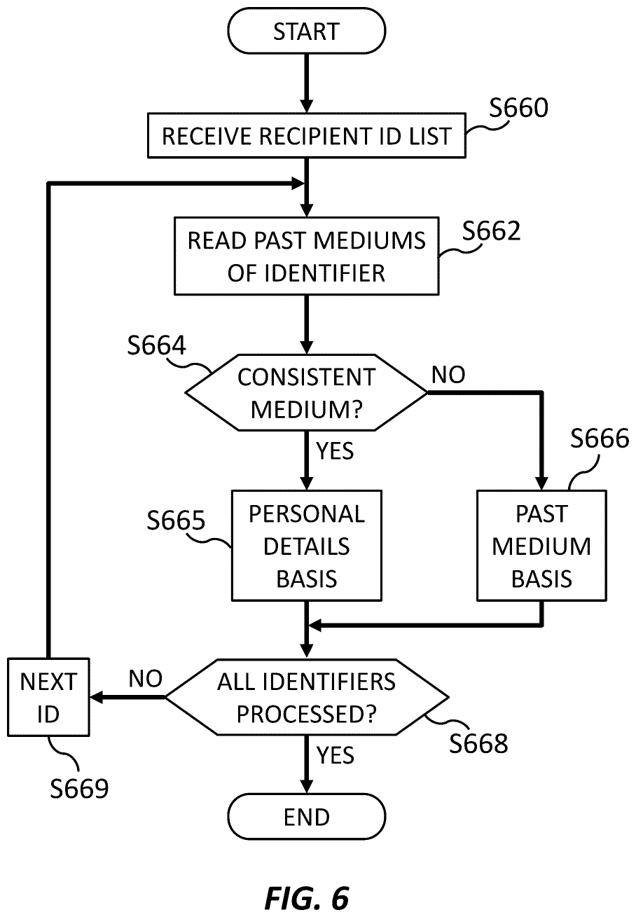

FIG. 6 is an operational flow for transmission channel determination, according to at least some embodiments of the present invention. The operational flow provides a method of transmission channel determination. In at least some embodiments, one or more operations of the method are performed by a determining section of an apparatus, such as the apparatus shown in FIG. 8, which will be explained hereinafter.

At S660, the determining section or a sub-section thereof receives a list of recipient individual identifiers. In at least some embodiments, the determining section receives a list of recipient individual identifiers from a selecting section. In at least some embodiments, the determining section instructs the receiving section to receive the list of recipient individual identifiers.

At S662, the determining section or a sub-section thereof reads past mediums of an individual identifier. In at least some embodiments, the medium is a Short Message Service (SMS) communication or an electronic mail communication. In at least some embodiments, the determining section reads past mediums associated with the individual identifier in the recipient individual identifier list from an access notices database, such as access notices database 117 of FIG. 1. In at least some embodiments, the determining section reads pre-processed information describing access mediums of the individual identifier from an individual attribute database, such as individual attribute database 192 of FIG. 1.

At S664, the determining section or a sub-section thereof determines whether there is a consistent medium associated with the individual identifier. In at least some embodiments, the determining section determines whether a use proportion of a past medium associated with the individual identifier in an access notices database is greater than a threshold value. In at least some embodiments, the determining section determines whether a pre-calculated use proportion value stored in an individual attribute database is greater than a threshold value. If the determining section determines that there is a consistent medium associated with the individual identifier, then the operational flow proceeds to past medium based transmission channel determination at S666. If the determining section determines that there is not a consistent medium associated with the individual identifier, then the operational flow proceeds to personal detail based transmission channel determination at S665.

At S665, the determining section or a sub-section thereof determines the transmission channel based on personal details of the individual identifier. In at least some embodiments, the determining section reads user-provided demographic information from a personal details database, such as personal details database 118 of FIG. 1. In at least some embodiments, the determining section reads pre-processed user-provided demographic information from an individual attribute database, such as individual attribute database 192. In at least some embodiments, the determining section applies one or more rules for determining a transmission channel based on personal details. For example, if the personal details reveal that the individual identifier does not subscribe to an SMS plan, then the determining section determines a transmission channel that is not through an SMS medium.

At S666, the determining section or a sub-section thereof determines the transmission channel based on past mediums of the individual identifier. In at least some embodiments, the determining section refers to the medium to determine the transmission channel. In at least some embodiments, the determining section determines that the past medium of highest use proportion is the transmission channel. In at least some embodiments, the determining section changes the past medium based transmission channel based on personal details.

At S668, the determining section or a sub-section thereof determines whether all of the individual identifiers in the recipient list received at S660 have been processed. If the determining section determines that one or more individual identifiers in the recipient list received at S660 remain unprocessed, then the operational flow returns to past medium reading at S662 after selecting the next individual identifier at S669. If the selecting section determines that all of the individual identifiers in the recipient list received at S660 have been processed, then the operational flow ends.

In at least some embodiments, more transmission aspects are determined other than transmission time and transmission channel, and more channels are considered than just SMS or email. In at least some embodiments, transmission channels include instant messaging, voice calling, postal mailing, proprietary application messaging, or any other form of transmission. In at least some embodiments, many more transmission aspects are determined one at a time or in parallel.

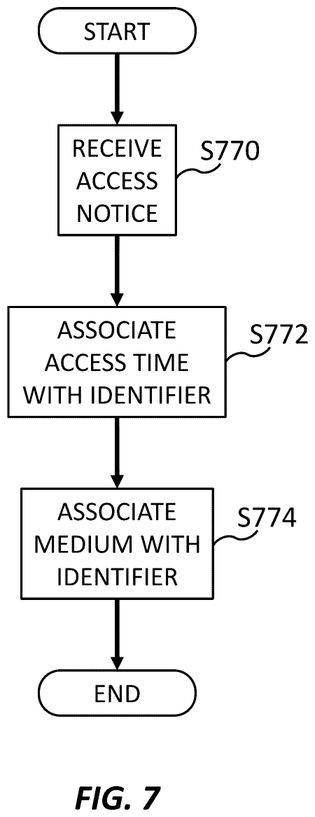

FIG. 7 is an operational flow for attribute association based on previously transmitted communications, according to at least some embodiments of the present invention. The operational flow provides a method of attribute association based on previously transmitted communications. In at least some embodiments, one or more operations of the method are performed by a determining section of an apparatus, such as the apparatus shown in FIG. 8, which will be explained hereinafter.

At S770, the determining section or a sub-section thereof receives an access notice. In at least some embodiments, the determining section receives an access notice from an individual communication device in response to the individual communication device being instructed by a user associated with an individual identifier to follow the link of access notice trigger of a previously transmitted communication, such as access notice trigger 224 of FIG. 2. In at least some embodiments, the determining section receives a notice indicating that a previously transmitted communication associated with the individual identifier has been accessed. In at least some embodiments, the determining section instructs the receiving section to receive the access notice.

At S772, the determining section or a sub-section thereof associates an access time with the individual identifier. In at least some embodiments, the determining section reads a time of day as the access notice is received, and associates the time of day with the individual identifier as an access time. In at least some embodiments, the determining section associates an access time with the individual identifier, the access time reflecting a time of day of reception of the notice. In at least some embodiments, the determining section stores the association in an individual attribute database, such as individual attribute database 192 of FIG. 1.

At S774, the determining section or a sub-section thereof associates a medium with the individual identifier. In at least some embodiments, the determining section associates a medium used to read the previously transmitted communication with the individual identifier as an access time. In at least some embodiments, the access notice specifies the medium used to read the previously transmitted message. In at least some embodiments, the determining section associates a medium of the previously transmitted communication with the individual identifier. In at least some embodiments, the determining section stores the association in an individual attribute database, such as individual attribute database 192 of FIG. 1.

FIG. 8 is a block diagram of a hardware configuration for individual attribute-based transmission aspect determination, according to at least some embodiments of the present invention.

The exemplary hardware configuration includes apparatus 800, which interacts with input device 809, and communicates with network 814. In at least some embodiments, apparatus 800 is integrated with input device 809. In at least some embodiments, apparatus 800 is a computer system that executes computer-readable instructions to perform operations for physical network function device access.

Apparatus 800 includes a controller 802, a storage unit 804, a communication interface 806, and an input/output interface 808. In at least some embodiments, controller 802 includes a processor or programmable circuitry executing instructions to cause the processor or programmable circuitry to perform operations according to the instructions. In at least some embodiments, controller 802 includes analog or digital programmable circuitry, or any combination thereof. In at least some embodiments, controller 802 includes physically separated storage or circuitry that interacts through communication. In at least some embodiments, storage unit 804 includes a non-volatile computer-readable medium capable of storing executable and non-executable data for access by controller 802 during execution of the instructions. Communication interface 806 transmits and receives data from network 814. Input/output interface 808 connects to input device 808 via a parallel port, a serial port, a keyboard port, a mouse port, a monitor port, and the like to exchange information.

Controller 802 includes receiving section 880, selecting section 882, determining section 884, and transmitting section 886. Storage unit 804 includes communications 890, attribute database 892, geographic data 894, and location parameters 896.

Receiving section 880 is the circuitry or instructions of controller 802 configured to receive data. In at least some embodiments, receiving section 880 is configured to receive communications, individual identifier lists, recipient lists, access notices, etc. In at least some embodiments, receiving section 880 records information in storage unit 804, such as communications 890. In at least some embodiments, receiving section 880 includes sub-sections for performing additional functions, as described in the foregoing flow charts. In at least some embodiments, such sub-sections is referred to by a name associated with a corresponding function.

Selecting section 882 is the circuitry or instructions of controller 802 configured to select individual identifiers. In at least some embodiments, selecting section 882 is configured to select, from a list of individual identifiers, an individual identifier for transmission of a communication based on a target attribute. In at least some embodiments, selecting section 882 utilizes information in storage unit 804, such as attribute database 892. In at least some embodiments, selecting section 882 includes sub-sections for performing additional functions, as described in the foregoing flow charts. In at least some embodiments, such sub-sections is referred to by a name associated with a corresponding function.

Determining section 884 is the circuitry or instructions of controller 802 configured to determine transmission aspects. In at least some embodiments, determining section 884 is configured to determine, for a selected individual identifier, a transmission aspect in which to transmit a communication. In at least some embodiments, determining section 884 utilizes information from storage unit 804, such as attribute database 892, geographic data 894, and location parameters 896. In at least some embodiments, determining section 884 includes sub-sections for performing additional functions, as described in the foregoing flow charts. In at least some embodiments, such sub-sections is referred to by a name associated with a corresponding function.

Transmitting section 886 is the circuitry or instructions of controller 802 configured to transmit communications. In at least some embodiments, transmitting section 886 is configured to transmit a communication through a determined transmission aspect. In at least some embodiments, transmitting section 886 utilizes information in storage unit 804, such as communications 890. In at least some embodiments, transmitting section 886 includes sub-sections for performing additional functions, as described in the foregoing flow charts. In at least some embodiments, such sub-sections is referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

According to at least some embodiments of the present invention, individual attribute-based transmission aspect determination is performed by receiving a communication associated with a target attribute, selecting, from a list of individual identifiers, an individual identifier for transmission of the communication based on the target attribute, determining, for the selected individual identifier, a transmission aspect in which to transmit the communication, and transmitting the communication through the determined transmission aspect.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a computer to cause the computer to perform operations comprising:
receiving a communication associated with a target attribute;
selecting, from a list of individual identifiers, an individual identifier for transmission of the communication based on the target attribute;
determining, for the selected individual identifier, a transmission aspect in which to transmit the communication; and
transmitting the communication through the determined transmission aspect.

2. The computer-readable medium of claim 1, wherein the target attribute includes a geographic area.

3. The computer-readable medium of claim 2, wherein the operations further comprise:
associating the individual identifier with a location based on an access point of a radio access network receiving the individual identifier to establish a connection.

4. The computer-readable medium of claim 3, wherein the selecting includes:
comparing the geographic area of the target attribute to the location associated with the individual identifier.

5. The computer-readable medium of claim 1, wherein the transmission aspect includes a transmission channel and a transmission time.

6. The computer-readable medium of claim 5, wherein the operations further comprise:
receiving a notice indicating that a previously transmitted communication associated with the individual identifier has been accessed; and
associating an access time with the individual identifier, the access time reflecting a time of day of reception of the notice.

7. The computer-readable medium of claim 6, wherein the operations further comprise:
associating a medium of the previously transmitted communication with the individual identifier.

8. The computer-readable medium of claim 7, wherein the medium is a Short Message Service (SMS) communication or an electronic mail communication.

9. The computer-readable medium of claim 8, wherein the determining includes:
referring to the access time to determine the transmission time and the medium to determine the transmission channel.

10. A computer-implemented method comprising:
receiving a communication associated with a target attribute;
selecting, from a list of individual identifiers, an individual identifier for transmission of the communication based on the target attribute;
determining, for the selected individual identifier, a transmission aspect in which to transmit the communication; and
transmitting the communication through the determined transmission channel at the determined transmission time.

11. The computer-implemented method of claim 10, wherein the target attribute includes a geographic area.

12. The computer-implemented method of claim 11, further comprising:
associating the individual identifier with a location based on an access point of a radio access network receiving the individual identifier to establish a connection.

13. The computer-implemented method of claim 12, wherein the selecting includes:
comparing the geographic area of the target attribute to the location associated with the individual identifier.

14. The computer-implemented method of claim 10, wherein the transmission aspect includes a transmission channel and a transmission time.

15. The computer-implemented method of claim 14, further comprising:
receiving a notice indicating that a previously transmitted communication associated with the individual identifier has been accessed; and
associating an access time with the individual identifier, the access time reflecting a time of day of reception of the notice.

16. The computer-implemented method of claim 15, wherein the operations further comprise:
associating a medium of the previously transmitted communication with the individual identifier.

17. The computer-implemented method of claim 16, wherein the medium is a Short Message Service (SMS) communication or an electronic mail communication.

18. The computer-implemented method of claim 17, wherein the determining includes:
referring to the access time to determine the transmission time and the medium to determine the transmission channel.

19. An apparatus comprising:
a controller including circuitry configured to
receive a communication associated with a target attribute;
select, from a list of individual identifiers, an individual identifier for transmission of the communication based on the target attribute;
determine, for the selected individual identifier, a transmission aspect in which to transmit the communication; and
transmit the communication through the determined transmission channel at the determined transmission time.

20. The apparatus of claim 19, wherein the circuitry is further configured to:
associate the individual identifier with a location based on an access point of a radio access network receiving the individual identifier to establish a connection.
